(19) United States
(12) Patent Application Publication
(10) Pub. No.: US 2018/0086146 A1
(43) Pub. Date: Mar. 29, 2018

(54) HEAVY DUTY TIRE AND TREAD

(71) Applicant: The Goodyear Tire & Rubber Company, Akron, OH (US)

(72) Inventors: John David WILSON, Clinton, OH (US); Gregory Alan SCHESSLER, Stow, OH (US); Todd David SPENCER, Hartville, OH (US); David Ray HUBBELL, Hartville, OH (US)

(21) Appl. No.: 15/706,988

(22) Filed: Sep. 18, 2017

Related U.S. Application Data
(60) Provisional application No. 62/399,458, filed on Sep. 25, 2016.

(51) Int. Cl. B60C 11/03

(52) U.S. Cl. CPC B60C 11/0332; B60C 2200/065; B60C 11/0316

(57) ABSTRACT

A heavy-duty tire is described herein. The heavy duty tire includes a carcass, a tread located radially outward of the carcass, and a tread having a plurality of lugs. The lugs extend radially outward from an inner tread and are located between the first and second lateral tread edges. The tread further includes a first row of lugs extending from the tread lateral edge axially inwards toward the centerplane, and a second row of lugs extending from the opposite tread lateral edge and axially inwards toward the centerplane. The lugs of the first and second rows are separated by a plurality of shoulder grooves, wherein the first row of lugs are aligned with the second row of lugs, a center row of lugs located between a first and second offset lug, wherein all of the lugs in each row are aligned circumferentially.

### FIELD OF THE INVENTION

The present invention relates to pneumatic tires, and more particularly to very large, wide base tires for use for example, on construction vehicles such as earth movers, and rigid haul dump trucks.

### BACKGROUND OF THE INVENTION

In very large tires having a diameter of 80 inches or more, tire operating conditions can be severe because of the extreme tire loading and off-road conditions. Furthermore, the speed of the vehicles may be high, which can result in excessive heat build-up in the tire. When a very large off the road tire is used in the oil sands environment, the tires are subjected to extreme dynamic and static loads. During vehicle operation, the tire may bounce through the thick, viscous sand conditions. The tire conditions result in the tire bouncing and deflecting, which can result in the tire failing earlier that its predicted life due to heat, high strain and bead failure. Thus it is desired to have an improved tire which is a cooler running tire.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 7° to 36° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“net to gross ratio” means the ratio of the area of the tread in the footprint that contacts the road to the total area of the tread in the footprint.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a perspective view of a tire of the present invention;

FIG. 2A is a front view of the tread of a control tire and FIG. 2B is a front view of the tread of the present invention;

FIG. 3 is a close-up front view of the tire tread of the present invention;

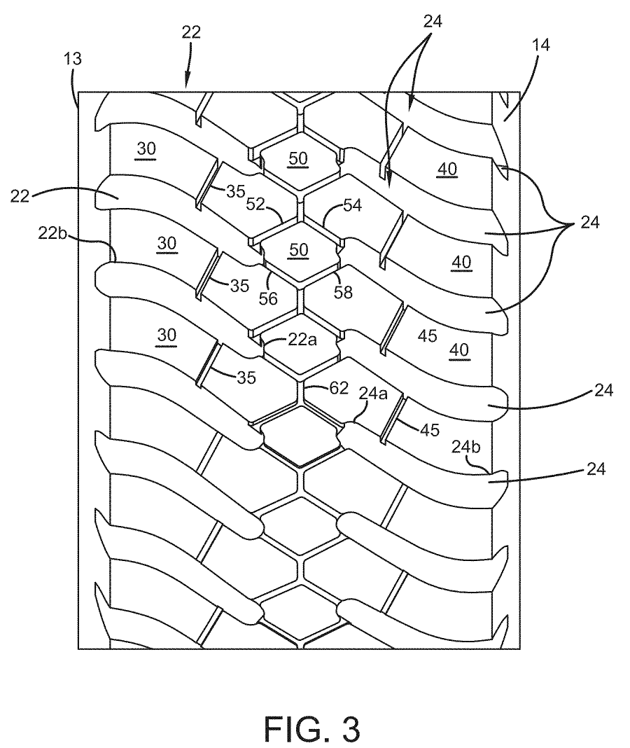

FIG. 4 is a close up side view of the tire of the present invention;

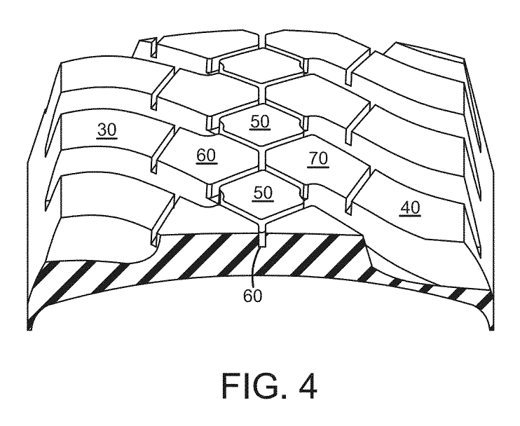

FIG. 5 is a schematic of the tire molded profile as compared to a control tire.

FIG. 6A illustrates the footprint of a control tire and FIG. 6B illustrates the footprint of the tire of the present invention.

### DETAILED DESCRIPTION OF THE INVENTION

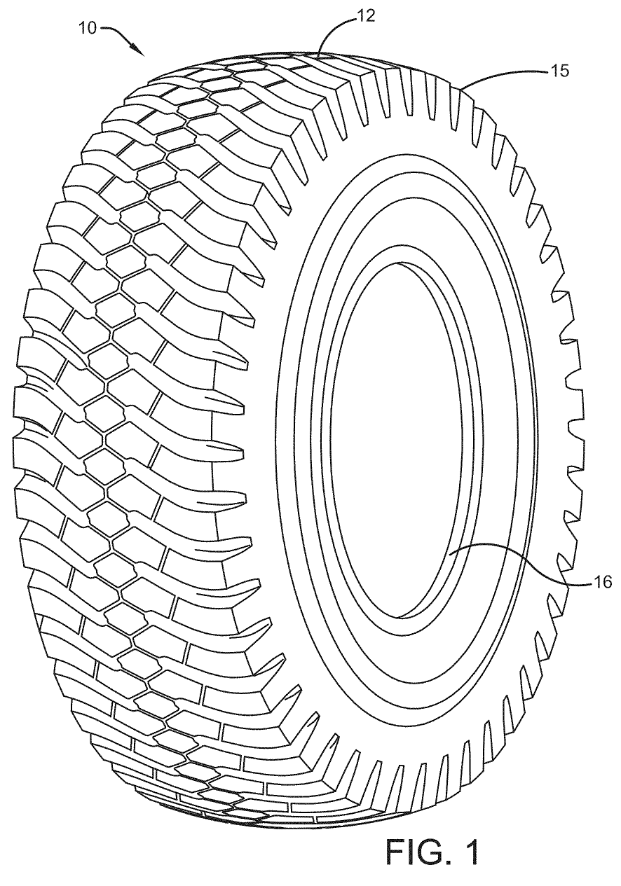

FIG. 1 illustrate a first embodiment of a tire 10 of the present invention. The tire may have a nominal rim diameter of 35 inches or more. The tire may have a nominal rim diameter of 35 inches or more. The tire 10 has an outer ground engaging tread portion 12 which has axially outer lateral edges 13, 14. Sidewalls 15 extend radially inward from the tread lateral edges 13,14 and terminate in a pair of bead regions 16 having an annular bead core (not shown). The tire 10 is further provided with a carcass which has a reinforcing ply structure (not shown) which extends from bead region to bead region. The tire may further include breakers and other tire components known to those skilled in the art.

The tire tread 12 preferably has a non-directional tread pattern. The tire tread 12 comprises two rows of shoulder grooves 22,24 wherein each row of shoulder grooves extend from a respective lateral tread edge 13,14 towards the centerplane of the tread. The shoulder grooves 22,24 do not cross the centerline of the tread and are angled at an angle θ1, θ2. The shoulder grooves in the first row 22 each have a first axially inner end 22a which are aligned with an axially inner end 24a of a shoulder groove 24, so that if groove 22 extended across the entire lateral width of the tire, it would substantially overlap with the opposite groove 24. The shoulder grooves in the first row 22 are similarly shaped as the shoulder grooves in the second row, and have an angular orientation that is rotated about 180 degrees out of phase from the other row. The shoulder grooves are deep, and have a depth of 70-100% of the non-skid tread depth, or NSK, and more preferably 90-100% of the NSK. The shoulder grooves 22,24 are angled at an angle θ1, θ2 in the range of about 20-65 degrees, more preferably in the range of about 30 to 55 degrees, and more preferably 30-45 degrees. The high angled grooves provide forward and lateral traction. The width of the shoulder grooves are about 25-40% of the tread width W, and more preferably 30-38% of the tread width W.

The tread is further divided into four rows of lugs. A first row of lugs is comprised of circumferentially aligned lugs 30 which extend from the lateral tread edge 13 to a cross groove 35. Each lug in row 30 is further bounded by two shoulder grooves 22, and have the same angular orientation as the shoulder grooves 22. Each lug has a width of about ⅔ the width of the shoulder grooves 22. The tread has cross grooves 35 which are circumferentially aligned and extend in a circumferential direction completely across the lugs 30 joining the shoulder grooves 22. The cross grooves 35 is a deep groove whose depth varies from about 90% to about 100% NSK, more preferably about 95% NSK. The cross groove 35 has a width of about 10% to about 20% of the width of the shoulder grooves 22. The cross grooves 35 form a small angle of about 10-15 degrees with the circumferential direction.

The tread further comprises a second circumferentially aligned row of lugs 40. The second row is comprised of lugs 40 which extend from the opposite lateral tread edge 14 and axially inward to a second row of cross grooves 45. Each lug 40 is further bounded by two shoulder grooves 24, and have the same angular orientation as the shoulder grooves. Each lug has a width of about ⅔ the width of the shoulder grooves 24. The cross grooves 45 are circumferentially aligned and extends in a circumferential direction completely across the lug 40 joining the adjacent shoulder grooves 24. The cross groove 45 depth varies from about 90% to about 100% NSK, more preferably about 90% NSK. The second groove has a width of about 10% to about 20% of the width of the shoulder grooves.

The tread further comprises a third circumferentially spaced row of center lugs 50. The center lugs 50 may or may not be the same size. The axially outer ends of lugs are defined by grooves 52, 54,56,58 which are arranged to form a diamond like shape of lug 50. A circumferential groove 60 joins each center lug 50. Grooves 52,54,56,58 are deep grooves, and preferably have a depth of 70-100% NSK. The circumferential groove 60 may further comprise tie bars 62 to help stiffen the center tread region. The tire bars have a height about 50% of the NSK. Each circumferential groove 60 is preferably oriented on the centerline of the tread.

The tire tread further comprises center offset lugs 60 and 70. Center offset lug 60 is located between shoulder lug 30 and center lug 50. Offset lug 70 is located adjacent center offset lug 60, and is separated from lug 60 by center circumferential groove 60. Offset lug 70 is located between shoulder lug 40 and center lug 50. Center circumferential grooves 60 are shallow, and have a depth of 10-20% NSK.

The overall net to gross ratio of the tire ranges from about 60 to about 80, more preferably about 65 to 75, and most preferably in the range of about 68 to 72.

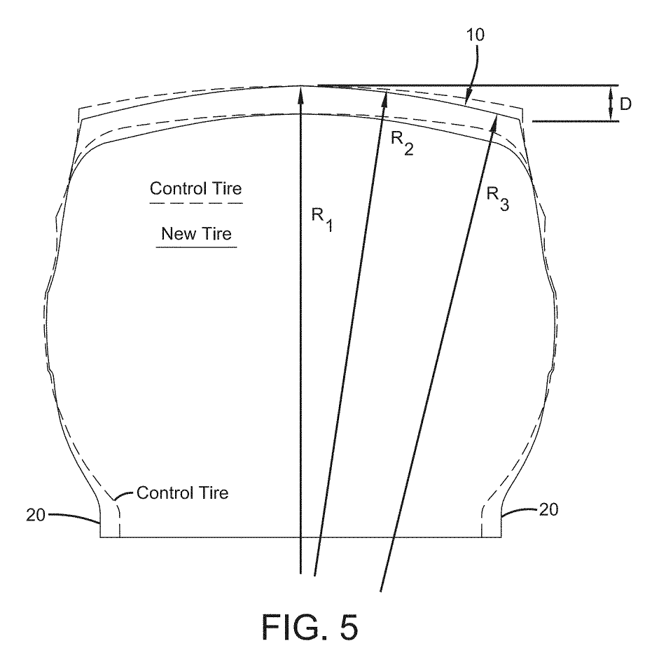

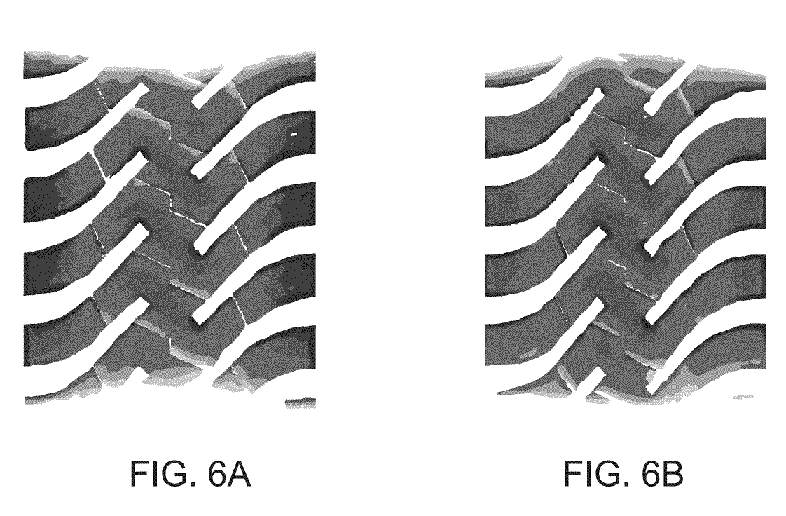

As shown in FIG. 5, the tire 10 of the present invention has a wider molded base width, so that the bead areas 20 are spaced farther apart as compared to a control tire. Preferably, the molded base width is in the range of 40 to 50 inches, more preferably in the range of 44-49 inches. The reduction of molded base width results in a reduced section width. Preferably, the molded base width is wider than the rim width. The reduced molded base width results in a more stable tire, and reduced section width that has lower rolling resistance. The reduced molded base width also results in a crown of the tire that has increased load bearing resulting in a more rounded footprint, as shown in FIG. 6.

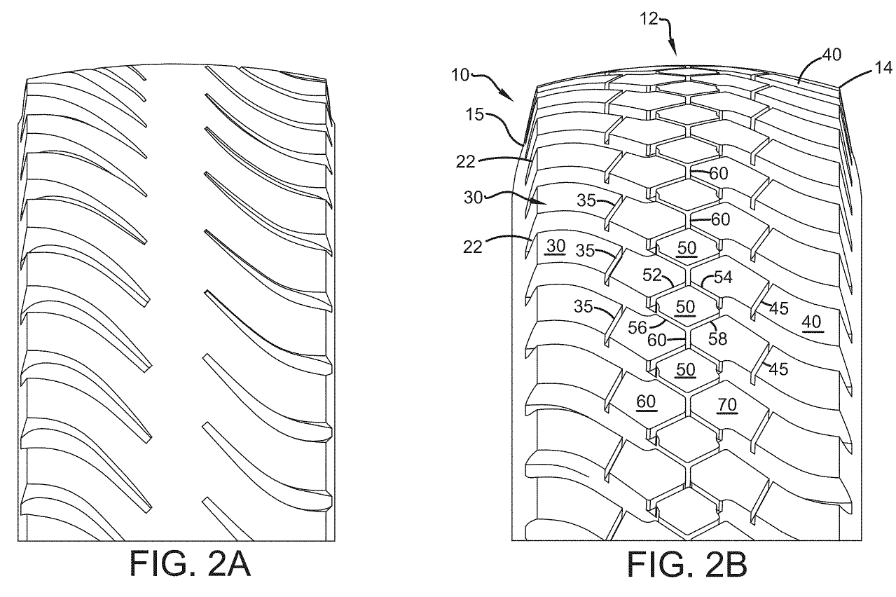

As shown in FIG. 6 and in FIG. 2b, the shoulder drop has been increased as compared to the control tire, which is shown in FIG. 2a. Preferably, the shoulder drop D ranges from 64 mm to 120 mm, and more preferably in the range of 85-115, and more preferably 93-97. As shown in FIG. 2b as compared to the control tire in FIG. 2a, the tread profile has more rounded edges. As shown in FIG. 5, the tread has a multi radius tread, R1 in the center, R3 at the shoulder, and R2 therebetween. In this example, R1 is 2325 mm, R2 is 1800 mm, and R3 is 1400 mm R1 may range from 2200-2500 mm, R2 is less than R1, R2 may range from 1600-2100 mm, and R3 may range from 1000-1500 mm.

The tread and carcass design has an improved overall performance resulting in an improved footprint and improved distribution of the heat load.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A heavy-duty tire comprising a carcass, a tread located radially outward of the carcass, the tread having a plurality of lugs, the lugs extending radially outward from an inner tread and being located between first and second lateral tread edges, a first row of lugs extending from the tread lateral edge axially inwards toward the centerplane, a second row of lugs extending from the opposite tread lateral edge and axially inwards toward the centerplane and wherein the lugs of the first and second rows are separated by a plurality of shoulder grooves, wherein the first row of lugs are aligned with the second row of lugs, a center row of lugs located between a first and second offset lug, wherein all of the lugs in each row are aligned circumferentially.

2. The heavy-duty tire of claim 1 wherein the center lugs are joined to each other by a center groove.

3. The heavy-duty tire of claim 2 wherein at least one of the center grooves has a tie bar.

4. The heavy-duty tire of claim 1 wherein said tire has a molded base width in the range of 44-50 mm.

5. The heavy-duty tire of claim 1 wherein the shoulder drop ranges from 64 mm to 120 mm.

6. The heavy-duty tire of claim 1 wherein the gauge of the shoulder wedge ranges from 70-89 mm.

7. The heavy-duty tire of claim 1 wherein the gauge of the shoulder wedge ranges from 75-85 mm.

8. The heavy-duty tire of claim 1 wherein the width of the fourth belt ranges from 744 to 780 mm, and more preferably 760 to 770 mm.

9. The heavy-duty tire of claim 1 wherein the fourth belt width is 55 to 65% of the tread arc width.

10. The heavy-duty tire of claim 1 wherein the gauge of the turn up pad is preferably in the range of 35-46 mm.

11. The heavy-duty tire of claim 1 wherein the tread has a multi radius tread.

12. The heavy-duty tire of claim 1 wherein the tread has a multi radius tread, wherein R1 may range from 2200-2500 mm, R2 is less than R1, R2 may range from 1600-2100 mm, and R3 may range from 1000-1500 mm.

13. The heavy-duty tire of claim 1 wherein the gauge of the turn up pad is preferably in the range of 38-43 mm.
